(19) United States
(12) Patent Application Publication
(10) Pub. No.: US 2003/0047217 A1
(43) Pub. Date: Mar. 13, 2003

(54) Precompression control arrangement

(75) Inventors: Werner Buse, Kaarst (DE); Albert Denne, Meerbusch (DE)

Correspondence Address: JULIAN H. COHEN, Ladas & Parry, 26 West 61st Street, New York, NY, 10023, US

(73) Assignee: PIERBURG GMBH

(21) Appl. No.: 10/236,763

(22) Filed: Sep. 6, 2002

(30) Foreign Application Priority Data
Sep. 7, 2001 (DE) 101 43 892.3

(51) Int. Cl. G05D 16/08

(52) U.S. Cl. 137/565.17

(57) ABSTRACT

A precompression control arrangement for the supply of fuel from a fuel pump arranged in a fuel tank to a fuel line and then to a fuel distributer of an internal combustion engine. A pressure-regulating valve is arranged in the fuel tank, which diverts fuel from the fuel line when the valve is opened and returns the fuel to the fuel tank. The pressure-regulating valve has first and second chambers, separated in a liquid-tight manner by a membrane which actuates a valve closing member. The first chamber has at least one inlet, connected to the fuel line by a first branch line, and at least one outlet, which leads into the fuel tank. The second chamber has a spring which biasses the valve closing member in the closing direction. The second chamber has a second inlet, which is connected to the fuel line by a second branch line which incorporates a switch such that different pressure levels can be adjusted in the second chamber.

### FIELD OF THE INVENTION

The invention relates to a precompression control arrangement for the fuel intake of a fuel precompression pump arranged in a fuel tank. The fuel intake takes place through a fuel line to a fuel high-pressure pump of an internal combustion engine. A pressure-regulating valve is arranged in the fuel tank, which is opened to return fuel from the fuel line back into the fuel tank. The pressure-regulating valve has first and second chambers, which are separated from one another in a liquid-tight manner by a membrane actuating a valve closing member. The first chamber has at least one inlet connected to the fuel line by a first branch line and at least one outlet, which leads into the fuel tank, the second chamber containing a spring that biasses the valve closing member in the closing direction.

### BACKGROUND

Such arrangements are known, for example, in direct fuel injection systems, wherein, fuel is returned to the fuel tank by of a precompression-regulating device. In the start-up phase, the precompression-regulating device is deactivated by a blocking valve. The pressure produced by the fuel precompression pump is limited in this case by the pressure-regulating valve. After opening the blocking valve, the precompression to the high-pressure fuel pump is determined by the precompression control device. In this pressure-regulation arrangement, the essential components are arranged outside the fuel tank, whereby the problem arises of satisfying increasingly stricter emission regulations. Also, a complicated construction with a relatively large number of components makes the arrangement expensive.

### SUMMARY OF THE INVENTION

An object of the present invention is to provide a precompression control arrangement, which avoids the above noted disadvantages.

This object is achieved according to the invention in that the second chamber of the pressure-regulating valve has a second inlet, which is connected to the fuel line by of a second branch line provided with a switching member, so that different pressure levels can be adjusted in the second chamber. It is now possible to arrange the components related to emission in the fuel tank so that a fuel system without a reversing motion can be obtained with a continuous fuel line, by means according to the invention. Only one pressure-regulating device is used whose pressure regulation can be controlled by switching on a correction pressure. The precompression control arrangement according to the invention thus assures that the pressure of the fuel pump can be adjusted to two pressure levels with one component. In a particularly simple embodiment, the second chamber has a second outlet leading to the fuel tank. A first nozzle with a diameter D1 is arranged in the second inlet and a second nozzle with a diameter D2 is arranged in the second outlet. Diameter D2 is larger than diameter D1, and the nozzles are dimensioned such that the drop in pressure in the two nozzles corresponds to the total pressure of the fuel pump. The switching member is a 2/2-way valve. However, a pressure limiting valve may also be arranged in the second outlet, which opens at a pressure increase for in the second chamber, in which case the switching member is a 3/2-way valve.

### BRIEF DESCRIPTION OF THE FIGURES OF THE DRAWING

FIG. 1 diagrammatically illustrates a first embodiment of a precompression control arrangement according to the invention.

FIG. 2 shows a second embodiment of the precompression control arrangement according to the invention.

### DETAILED DESCRIPTION

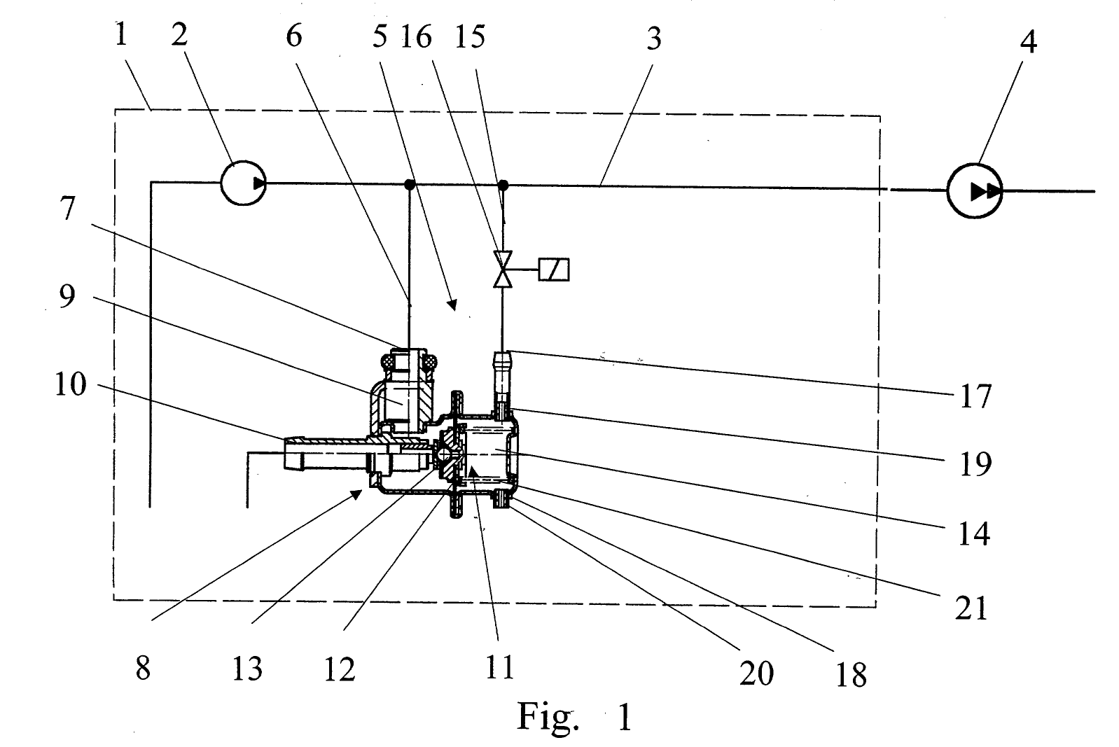

FIG. 1 shows in schematic form a flow path of fuel to an internal combustion engine with direct fuel injection. In FIG. 1 fuel is supplied to a high-pressure fuel pump 4 from a fuel tank 1 by a pump 2 through a fuel line 3. The high-pressure fuel pump is mechanically driven, for example, by a cam shaft of the internal combustion engine. Fuel injection valves are supplied with fuel in a fuel distributor (not shown) from the high-pressure fuel pump 4.

In order to assure that fuel is supplied at a defined pressure level to the high-pressure fuel pump 4, a precompression control arrangement 5 is provided in fuel tank 1 in addition to fuel precompression pump 2. By the construction of the precompression control arrangement 5 according to the invention, it is possible to concentrate numerous components, relevant to fuel delivery, in the fuel tank 1, and from which only one fuel line 3 extends outside of the fuel tank and conducts the fuel to the high-pressure fuel pump 4. A first branch line 6 extends from fuel line 3, and is connected to a first inlet 7 of a pressure-regulating valve 8. If the pressure-regulating valve 8 is in an open position, fuel flows into the first branch line 6 then into the inlet 7 and a first chamber 9 of valve 8 and by means of outlet 10 back tp the fuel tank 1. A valve assembly 11 of the pressure-regulating valve 8, comprises a valve closing member 13 supported on a membrane 12 which separates the first chamber 9 from a second chamber 14 in liquid tight manner.

The precompression control arrangement 5 according to the invention has a second branch line 15, which includes a switch means 16, and the branch line 15 extends to a second inlet 17 of the pressure-regulating valve 8. Fuel can be introduced into the second chamber 14 through the second inlet 17. Additionally, the pressure-regulating valve 8 has a second outlet 18. A nozzle 19 is arranged in the inlet 17 and a nozzle 20 is arranged in outlet 18. In order to be able to produce a drop in pressure in both nozzles, nozzle 20 is provided with a diameter D2, which is greater than the diameter D1 of nozzle 19. A spring 21 is provided in the second chamber 14 to bias the valve closing member 13 in the closing direction. The switch 16 is comprised of a simple 2/2-way valve.

The precompression control arrangement 5 according to FIG. 1 operates as follows:

In a first adjustment site of the precompression control arrangement 5, a fuel pressure of approximately 4 bars will be produced in the fuel line. The electromagnetic 2/2-way valve 5 is not supplied with current and is closed, so that an atmospheric pressure of 1 bar is present in the second chamber 12, and only the force of spring 21 acts on closing member 13. The spring force is adjusted such that closing member 13 opens at a pressure of more than 4 bars in the first chamber 9 and fuel is returned to the fuel tank via outlet 10. If a precompression pressure of 6-7 bars is required at the inlet of the high-pressure pump in the start-up and warm-up phases as well as in starting a hot engine, the switch 16 is opened and fuel can flow into the second chamber 14 via the second branch line 15 and the second inlet 17, whereby a drop in pressure of ΔP of 4 bars is produced at the first nozzle 19, which corresponds to the base pressure. A pressure drop of ΔP of 2-3 bars is produced in the nozzle 20, and this drop corresponds to the additional pressure that can be switched on. In the present embodiment, this means that the valve closing member 13 only opens at a pressure greater than 6-7 bars in the first chamber 9. By this simple construction, it is thus possible to rapidly adapt the pressure provided for the fuel distributor. It should be again noted that nozzles 19, 20 are dimensioned so that the sum of the pressure drops at nozzles 19,20 corresponds to the total pressure of the pump. In particular, the pressure drop at nozzle 19 corresponds to the basic pressure of pressure control arrangement 5 and the pressure drop at nozzle 20 corresponds to the additional pressure, which is necessary in the case of elevated line losses or a very high engine load. The speed of pressure adjustment is dependent on the dead volume of the regulation segment and the size of the nozzles. Large nozzles thus increase the adjustment speed, but also bring about a greater volume loss for fuel pump 2. Since both nozzles are subjected to the same laws of flow, the additional pressure is not influenced by marginal influences, such as fuel viscosity, fuel temperature or the like. It should be noted that the nozzles are only shown schematically and needle jets or the like can also be used.

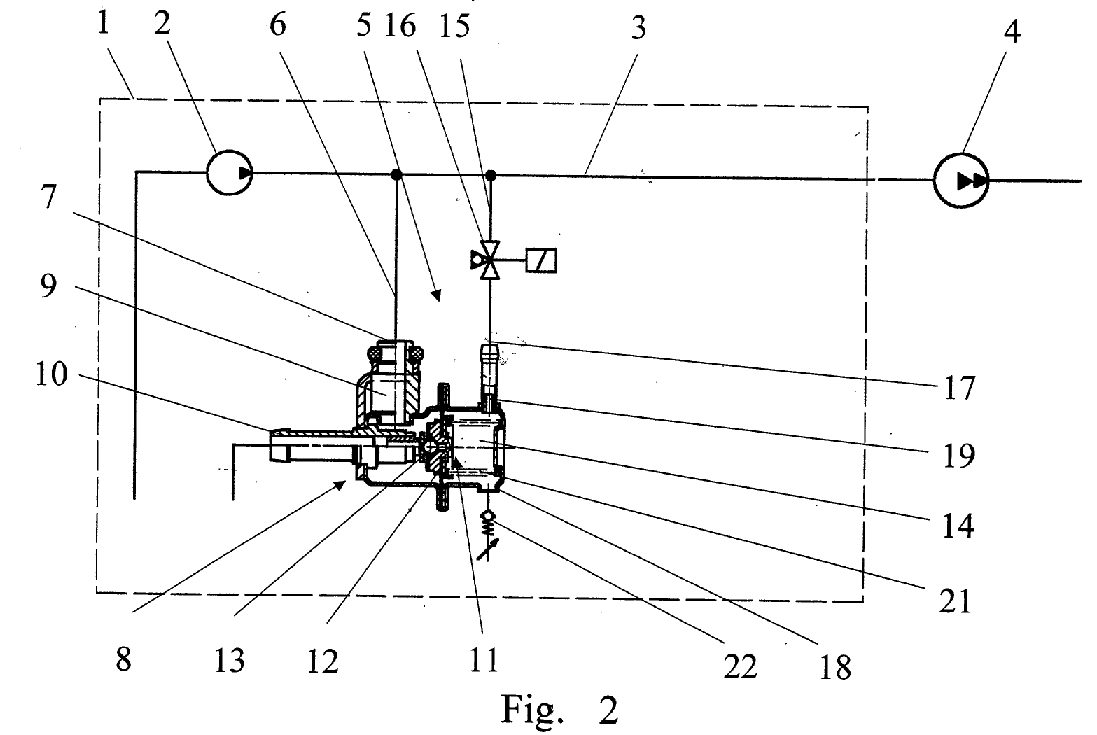

Another embodiment of the precompression control arrangement 5 according to the invention is shown in FIG. 2. In this embodiment, instead of nozzle 20, a pressure-relief valve 22 is arranged in the second outlet 18. The pressure relief valve 22 is designed so that it opens at a pressure of 6-7 bars. Since the connection of the second chamber 14 to the atmosphere is no longer assured by means of the outlet 18, a 3/2-way valve is utilized as the switch means 16 in the present embodiment. An adjustment of pressure from the base pressure to elevated pressure is produced more rapidly in this embodiment, since volume is not lost during the increase of pressure due to the pressure-relief valve 22. In addition, the pressure-relief valve 22 permits a precise adjustment of the additional pressure.

Although the invention is disclosed with reference to particular embodiments thereof, it will become apparent to those skilled in the art that numerous modifications and variations can be made which will fall within the scope and spirit of the invention as defined by the attached claims.

What is claimed is:

1. A precompression control arrangement for fuel supply from a fuel precompression pump arranged in a fuel tank to a fuel line connected to a fuel high-pressure pump of an internal combustion engine, said precompression control arrangement comprising a pressure-regulating valve disposed in the fuel tank, said valve having an open position in which fuel is diverted from the fuel line back into the fuel tank, said pressure-regulating valve having first and second chambers separated from one another in a liquid-tight manner by a membrane which actuates a valve closing member, said first chamber having at least one inlet connected by a first branch line to the fuel line, and at least one outlet, which leads into the fuel tank, the second chamber including a spring, which biasses the valve closing member in a closing direction, said second chamber of the pressure-regulating valve having a second inlet connected to the fuel line by a second branch line and a switch means in said second branch to provide adjustment of different pressure levels in the second chamber.

2. The precompression control arrangement according to claim 1, wherein the second chamber has a second outlet, a first nozzle having a diameter D1 being provided in said second inlet.

3. The precompression control arrangement according to claim 2, further comprising a second nozzle having a diameter D2 disposed in said second outlet, the diameter D2 being greater than the diameter D1, said first and second nozzles being dimensioned such that a pressure drop in the two nozzles corresponds to a total pressure of the fuel pump, said switch means comprising a 2/2-way valve.

4. The precompression control arrangement according to claim 1, further comprising a pressure-relief valve arranged in said second outlet, said pressure relief valve opening at a predetermined pressure increase in the second chamber, said switch comprising a 3/2-way valve.

5. The precompression control arrangement according to claim 4, comprising a nozzle in said second inlet.
